(19) United States
(12) Patent Application Publication
(10) Pub. No.: US 2009/0016563 A1
(43) Pub. Date: Jan. 15, 2009

(54) Micro-speaker

(75) Inventors: George Shaolin Wei, San Diego, CA (US); Dai Zo Lee, Anaheim, CA (US)

Correspondence Address: Venable, 2049 Century Park East, 21st Floor, LOS ANGELES, CA, 90067, US

(73) Assignee: Aurasound, Inc.

(21) Appl. No.: 11/827,870

(22) Filed: Jul. 14, 2007

(51) Int. Cl. H04R 1/00

(52) U.S. Cl. 381/430

(57) ABSTRACT

The present invention relates generally to a compact speaker which includes a diaphragm with an embedded voice coil on the surface of the diaphragm, and a magnet, secured in a frame. Due to the placement and orientation of the voice coil, the improved transducer is compact, easy to manufacture, robust and efficient.

### BACKGROUND OF THE INVENTION

1. Field of the Invention

The present invention relates generally to a compact speaker having an embedded voice coil on a dome-shaped diaphragm.

2. Background Information

A traditional loud speaker encompasses a number of common elements, including a diaphragm, a magnet assembly, a voice coil, a suspension system and a frame. Sound from a speaker is generated by air pressure created by movement of the diaphragm. The diaphragm is driven by a voice coil attached to its inner circumference and perpendicular to the plane of the diaphragm. When an electrical current is applied to the voice coil, an electrical force is generated which crosses magnetic flux from the magnet assembly. The cross product of the electric current density with the magnetic field causes axial movements of the voice coil and speaker's diaphragm along an axis orthogonal to the plane of the diaphragm. The movement of the diaphragm is maintained linearly by use of suspensions typically on the outer and inner circumference of the diaphragm, which are also known as a surround and spider, respectively.

The voice coil of a traditional speaker is coupled to the diaphragm with a former. Due to the orientation of the voice coil, a traditional speaker requires substantial space behind the diaphragm to accommodate its excursion, including additional space for the voice coil and the magnet assembly. The space requirement makes the design unsuitable for applications in smaller spaces. In particular, a traditional speaker is not well-suited in compact personal electronic devices such as mp3 players, laptop computers or even planar televisions.

Another issue with traditional speakers is the complexity of its design, which renders the traditional speaker more expensive to produce and susceptible to mechanical failure. A specific example is the tight spacing requirement for the gap between the voice coil and the magnet. Due to the tight spacing, when excessive current is applied to the voice coil, it may rock and rub against other speaker components, which effectively “blows out” the speaker.

A variation of the traditional speaker design is the planar speaker, or an acoustical electromagnetic transducer. A planar speaker typically uses a large rectangular sheet of membrane, or diaphragm, with an elongated conductor attached or bonded to its face. The diaphragm is positioned in parallel to a magnetic structure which encompasses a plurality of permanent magnet strips spaced along the runs of the conductor on the diaphragm. When electrical current is applied to the conductor, the magnetic flux causes the entire diaphragm to move uniformly, thereby generating air pressure and sound. Unlike traditional speakers, a planar speaker does not utilize a suspension system to accommodate the movement of the diaphragm. A planar speaker typically uses a thin diaphragm which, in contrast to the rigid diaphragm on a traditional loud speaker, has low mass and therefore low inertia and quick movement.

The planar speaker design has a number of notable deficiencies—particularly those related to the large surface area of its diaphragm. One such deficiency is the diaphragm's inability to move in the same order of magnitude as those in traditional speakers. Accordingly, planar speakers tend to be limited in its sound pressure output and are even more inefficient than traditional speakers. In addition, when driven hard under high current loads, the large diaphragm may flex unevenly and generate undesirable resonances which deteriorate the speaker's sound performance. The large surface area of the diaphragm and its thin membrane also make a planar speaker susceptible to physical damage. Finally, a planar speaker's large diaphragm makes it unsuitable for small electronic devices.

The present invention addresses many of the shortcomings of the traditional loud speaker design and the planar speaker design for application in compact speaker designs. The invention discloses a compact speaker that requires little depth with significantly higher sound pressure output over a broad range of frequency. The present invention incorporates an embedded voice coil which improves heat dissipation and the speaker's robustness, and decreases the likelihood of the speaker “blowing out.” The invention also allows for an increase in the amount of space between the voice coil and the magnet, which increases production tolerances and decreases cost of manufacture. The invention also incorporates a dome-shaped diaphragm to further increase its stiffness, reduce flexing, and improve the speaker's ability to handle increased sound pressure. The orientation of the embedded voice coil in the present invention also eliminates the need for a secondary suspension for controlling wobbling.

Finally, the embedded voice coil design reduces the number of moving parts and components compared to the traditional speaker. For example, a former is no longer needed to couple the voice coil to the diaphragm. This decreases the weight of the diaphragm and cost of production, while enhancing robustness.

From the preceding descriptions, it is apparent that the devices currently being used have significant disadvantages and/or limitations. Thus, important aspects of the technology used in the field of invention remain amenable to useful refinement.

### SUMMARY OF THE INVENTION

The present invention relates to a compact speaker comprised of an embedded voice coil on a dome shaped diaphragm. The essential components of such a speaker include a dome-shaped diaphragm with an embedded voice coil on the surface of the diaphragm, a suspension surrounding the diaphragm and a magnet. This assembly is secured in a frame. Due to the placement and orientation of the voice coil, the improved transducer is compact, easy to manufacture, robust and efficient.

All of the foregoing operational principles and advantages of the present invention will be more fully appreciated upon consideration of the following detailed description with reference to the drawings.

### BRIEF DESCRIPTION OF THE DRAWINGS

The features and advantages of this invention are better understood with regard to the following drawings, description, and claims. The drawings consist of the following:

FIG. 1 is the side view of a traditional speaker having a voice coil attached orthogonally to the plane of the diaphragm.

FIG. 2 is the perspective view of a speaker embodying features of this invention.

FIG. 3 is the elevational perspective view of a speaker embodying features of this invention.

FIG. 4 is the cross-sectional side view of a speaker embodying features of this invention.

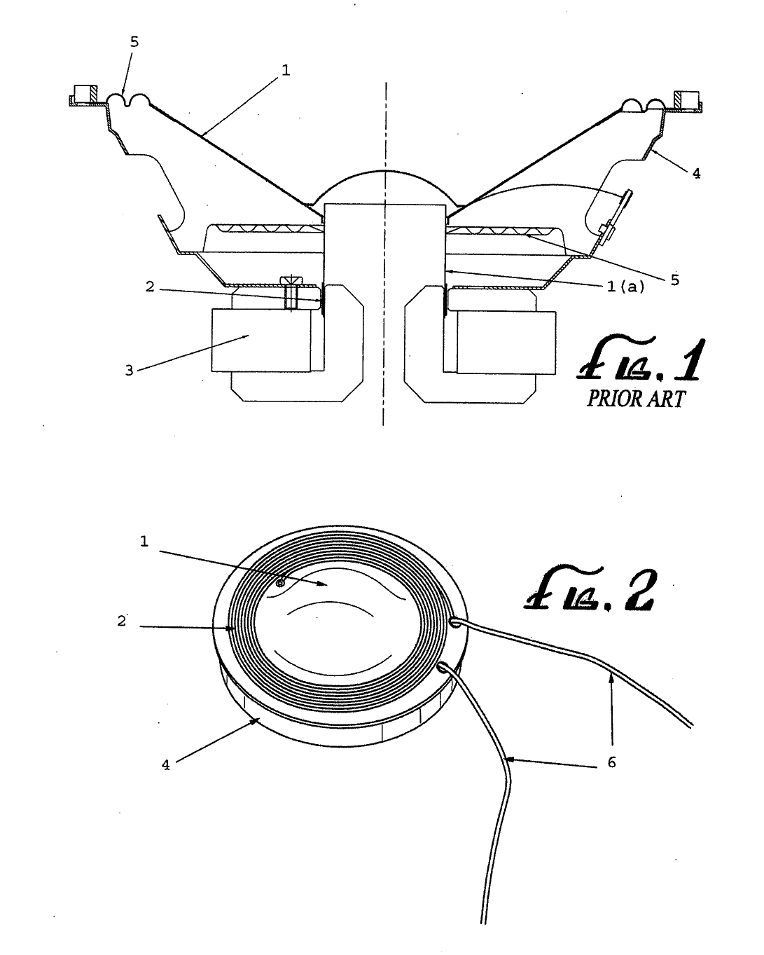

### DETAILED DESCRIPTION OF THE INVENTION

The essential components of a speaker as disclosed herein include a dome-shaped diaphragm 1 with an embedded voice coil 2 on the surface of the diaphragm and a magnet 3 positioned below the diaphragm and voice coil 2. The magnet is secured inside a frame 4. A suspension 5 secures the diaphragm 1 to the frame 4. The suspension 5, frame 4, and magnet 3 can be any sort commonly know to those skilled in the art and are thus not described herein.

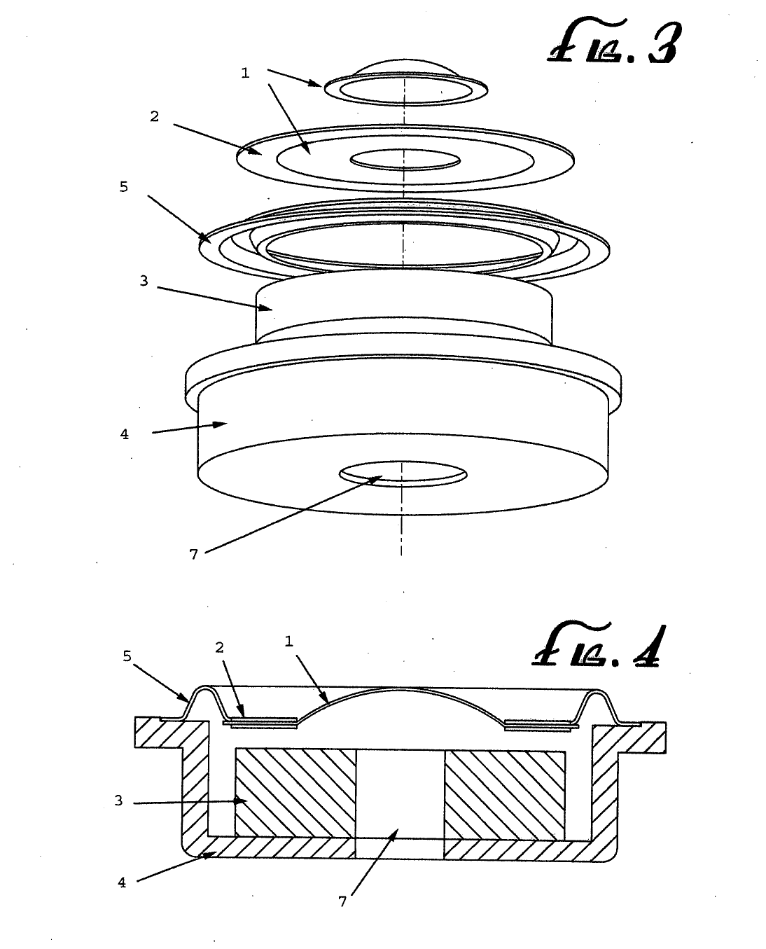

The preferred embodiment is better understood by reference to FIGS. 2 to 4. FIG. 2 is the perspective view showing a fully assembled speaker embodying features of this invention—showing the embedded voice coil 2 with speaker leads 6 secured in a compact and shallow frame. As seen in FIG. 3, the diaphragm 1 has a voice coil 2 embedded toward the outer perimeter of the dome shape in the diaphragm 1.

The diaphragm 1 may be composed of printed circuit boards or other light-weight material with relatively high rigidity. The dome in the center of the diaphragm 1 enhances its rigidity for improved handling of sound pressures. The centrally located dome segment of the diaphragm 1 can be either separate or integral with the flatter segment. The combination of these characteristics minimizes inertia, increases transient response and avoids buckling of the diaphragm 1 under increased pressure at high volume levels.

The voice coil 2 is positioned as a spiral around the periphery of the dome shape on the flat portion of the diaphragm 1. It is preferably attached by adhesive to the bottom surface of the flatter portion of the diaphragm 1 surrounding the dome, though it can be fixed on the diaphragm 1 in any manner readily known to those skilled in the art. By way of example, the voice coil 2 can also be fixed by etching, silk screen or adhesive. Additionally, the voice coil 2 can be placed on the top surface of the diaphragm 1 surrounding the dome. The voice coil 2 is thus preferably in the same plane as the flatter outer portion of the diaphragm 1.

A suspension 5 surrounds the voice coil 2 and connects the diaphragm 1 to the frame 4. The suspension 5 can be separate or integral with diaphragm 1. The material and manufacture of the suspension can be any sort commonly known to those skilled in the art.

FIG. 3 discloses the elements that comprise the present invention, which include a dome-shaped diaphragm 1 with an embedded voice coil 2 disposed on top of a permanent magnet 3. This assembly is secured in a speaker frame 4. The diaphragm 1, voice coil 2, magnet 3 and frame 4 are all mounted concentrically with an opening 7 through the center of the frame and the magnet to provide ventilation for dissipating heat generated by the voice coil 2 and for releasing back pressure build up by the diaphragm's excursion.

FIG. 4 discloses a voice coil 2 embedded on the dome-shaped diaphragm 1. The voice coil 2 is suspended above and toward the outer edge of a magnet 3. The diaphragm 1 has a dome-shaped center to provide for additional structural rigidity. When combined with the reinforcement from the voice coil, utilization of materials such as a thin PCB board may provide significantly higher sound pressure level output and broader frequency range when compared to application in traditional compact loudspeakers.

FIG. 4 also discloses that an embedded voice coil 2, when placed concentrically over and toward the outer edge of a magnet 3 allows for a greater gap between the magnet 3 and the voice coil 2. Whereas gaps for traditional compact speakers are approximately 0.1 mm, the gap for the present invention is substantially greater, making it easier and less expensive to manufacture.

It should be appreciated that although this preferred embodiment discloses a circular shaped micro-speaker and associated components, a square, ellipse, or any other appropriate shape may be used.

Although the present invention has been described in detail with respect to certain preferred versions thereof, other versions are possible. Therefore, the scope of the claims should not be limited to the description of the preferred versions contained herein.

1. A speaker comprised of:
(a) a diaphragm with a centrally located dome shape;
(b) an embedded voice coil on the surface of said diaphragm, said voice coil around the periphery of said dome shape;
(c) a suspension surrounding said voice coil; and
(c) a magnet;
(d) said diaphragm, said voice coil, said suspension, and said magnet secured in a frame.

2. The speaker of claim 1 wherein said diaphragm has a flatter outer portion surrounding the centrally located dome shape.

3. The speaker of claim 1 or 2 wherein said voice coil is positioned as a spiral around the periphery of the centrally located dome shape.

4. The speaker of claim 1 or 2 wherein said voice coil is positioned in the same plane as the flatter outer portion of said diaphragm.
